(19) United States
(12) Patent Application Publication
(10) Pub. No.: US 2025/0298719 A1
(43) Pub. Date: Sep. 25, 2025

(54) EVENT TIME RECORDING METHOD AND DATA STORAGE DEVICE

(71) Applicant: INNODISK CORPORATION, New Taipei City (TW)

(72) Inventor: JHE-YU LIN, New Taipei City (TW)

(21) Appl. No.: 18/646,780

(22) Filed: Apr. 26, 2024

(30) Foreign Application Priority Data
Mar. 25, 2024 (TW) 113111033

(51) Int. Cl. G06F 11/34; G06F 9/54

(52) U.S. Cl. CPC G06F 11/3495; G06F 9/542

(57) ABSTRACT

An event time recording method includes receiving an absolute time information sent from a computer host after a data storage device is powered on and the data storage device stores the absolute time information and the event log file in a specific storage area of the data storage device. The event time recording method can be used on the data storage device, and solves the problem of insufficient reference information in the confirmation and judgment of error analysis. A data storage device is also provided.

### CROSS-REFERENCE TO RELATED APPLICATION

This non-provisional application claims priority under 35 U.S.C. § 119(a) on Patent Application No(s). 113111033 filed in Taiwan, R.O.C. on Mar. 25, 2024, the entire contents of which are hereby incorporated by reference.

### BACKGROUND OF THE INVENTION

### 1. Field of the Invention

The present disclosure relates to methods of recording information about operations of computer devices, and in particular to an event time recording method and a data storage device.

### 2. Description of the Related Art

The basic input/output system (BIOS) of a host computer is activated to run the power-on self-test (POST) as soon as the host computer is powered on. Upon completion of the POST, logs of BIOS activities are created. BIOS logs can be accessed by computer technicians to check for errors in the boot process of the host computer so as to analyze and judge whether devices in the host computer are functioning correctly.

On the other hand, after being activated, existing data storage devices (for example, solid-state drives, SSDs) test themselves with the self-monitoring, analysis, and reporting technology (SMART) and write SMART information to the device logs of the data storage devices, allowing computer technicians to check the device logs for errors arising during the activation process of the data storage devices so as to analyze and judge whether the data storage devices are functioning correctly.

Computer technicians can access BIOS logs and device logs of SSDs to generally confirm errors or failures of any devices in a host computer and thereby troubleshoot. However, they are unable to precisely identify the causes of the errors or failures. Although the device logs of SSDs include time information (for example, the number of power-on hours), the time information is not absolute time information. As a result, the device logs of SSDs cannot be compared with BIOS logs to determine the sequence of events and thereby confirm their causality and determine whether the malfunctioning of the host computer is associated with problems with the devices.

In the aforesaid conventional troubleshooting process, one single type of log provides only basic reference information for use in error analysis. Furthermore, device logs of SSDs lack absolute time information and thus fail to be linked to and compared with BIOS logs to precisely troubleshoot problems. As a result, confirmation and judgment of error analysis is negatively affected by insufficient reference information.

### BRIEF SUMMARY OF THE INVENTION

In view of the aforesaid drawbacks of the prior art, it is an objective of the present disclosure to provide an event time recording method, applicable to a data storage device, with the data storage device adapted to coordinate with a host computer. The event time recording method comprises the steps of: receiving, after the data storage device has been powered on, an absolute time information sent from the host computer and storing, by the data storage device, the absolute time information and an event log file in a specific storage area in the data storage device.

In some embodiments, the host computer uses an Advanced Technology Attachment (ATA) command to send the absolute time information to the data storage device.

In some embodiments, record information of the event log file comprises an interface connection state, bad block position, bad block type, read failure, write failure, temperature, number of power-on hours, unrepairable position and/or error-correcting code.

In some embodiments, the data storage device regularly performs the step of storing the absolute time information and an event log file in a specific storage area in the data storage device.

In some embodiments, the data storage device performs the step of storing the absolute time information and an event log file in a specific storage area in the data storage device only if a specific event occurs.

In view of the aforesaid drawbacks of the prior art, it is an objective of the present disclosure to provide a data storage device for recording event time, and adapted to coordinate with a host computer. The data storage device comprises a controller, and a memory electrically connected to the controller and adapted to store a firmware code. The firmware code is executed by the controller to perform the steps of receiving an absolute time information from the host computer, and storing the absolute time information and an event log file in a specific storage area in the data storage device.

In conclusion, an event time recording method and a data storage device of the present disclosure are effective in acquiring absolute time information sent from a host computer and storing the absolute time information and an event log file in the data storage device in a specific storage area in the data storage device to enable computer technicians to compare BIOS logs with the event log files in terms of the absolute time information to not only easily and quickly identify the causality between related devices upon the occurrence of an event but also enhance the precision in the analysis and judgment of causes of errors or failures arising from the operation of the host computer.

### BRIEF DESCRIPTION OF THE DRAWINGS

FIG. 1 is a block diagram of a data storage device for recording event time according to an embodiment of the present disclosure.

FIG. 2 is a schematic view of a process flow of an event time recording method according to an embodiment of the present disclosure.

### DETAILED DESCRIPTION OF THE INVENTION

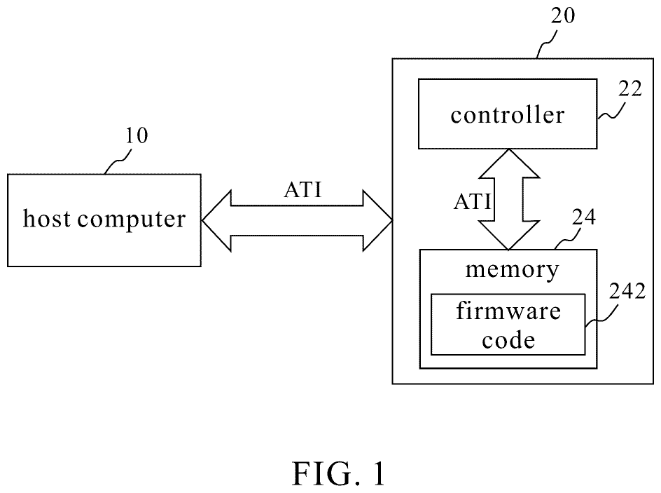

Referring to FIG. 1, which is a block diagram of a data storage device for recording event time according to an embodiment of the present disclosure. As shown in the block diagram, a data storage device 20 and a host computer 10 are electrically connected. The data storage device 20 is adapted to coordinate with the host computer 10, operating jointly to perform computer functions, such as command editing and executing, data storing, deleting, reading, transmitting, computing, receiving and writing, and/or controlling peripheral devices.

The host computer 10 comprises basic computer-related constituent components, such as a volatile memory (not shown), a nonvolatile memory (not shown), a central processing unit (not shown), a hard disk drive (not shown), a power supply (not shown), and a display device (not shown). The host computer 10 executes a boot program and creates BIOS logs, and the boot program is, for example, a power-on self-test (POST) program. The host computer 10 provides information (for example, absolute time information ATI) to the data storage device 20 according to a request sent from the data storage device 20. The absolute time information ATI is generated by a real-time clock (RTC) of the BIOS, but the present disclosure is not limited thereto. In a variant embodiment, the absolute time information ATI is derived from online time. The instances of the host computer 10 sending the absolute time information ATI are in the number of one or more. In an embodiment, the host computer 10 uses an Advanced Technology Attachment (ATA) command to send the absolute time information ATI to the data storage device 20. ATA commands are advantageously very secure, performance-friendly, easy and fast to enable or disable, and thus the process of recording event time with the data storage device 20 is relatively secure, performance-friendly, easy and fast to perform.

The data storage device 20 comprises a controller 22 and a memory 24. The data storage device 20 is, for example, a hard disk drive (HDD) or solid-state drive (SSD). The data storage device 20 is configured to test itself with the self-monitoring, analysis, and reporting technology (SMART) and write SMART information to an event log file. In an embodiment, the data storage device 20 stores an event log file comprising the absolute time information ATI in a specific storage area in the data storage device 20. Record information of the event log file comprises an interface connection state, bad block position, bad block type, read failure, write failure, temperature (for example, operating temperature of devices, such as DRAM, CPU, SSD, and display card), number of power-on hours, unrepairable position and/or error-correcting code (ECC). The interfaces include serial advanced technology attachment (SATA) hardware framework (for example, SATA-1, SATA-2, SATA-3), and periphery component interconnect express (PCIe) framework (for example, PCIe Gen1, PCIe Gen2, PCIe Gen3, PCIe Gen4).

The controller 22 executes a software program or firmware program to perform the aforesaid computer functions. The controller 22 is, for example, a central processing unit, a system-on-chip (SoC), a field programmable gate array (FPGA), an application specific integrated circuit (ASIC), a micro controller unit (MCU), a digital signal processor (DSP), a programmable logic device (PLD), or a controller of any other type. In an embodiment, the controller 22 executes a firmware code 242 stored in the memory 24 to perform the function of recording event time.

The memory 24 and the controller 22 are electrically connected. The memory 24 stores the firmware code 242. In an embodiment, the firmware code 242 is programmed to allow the data storage device 20 to take the initiative in sending a request to the host computer 10 after being powered on to receive the absolute time information ATI from the host computer 10. The memory 24 is nonvolatile memory, for example, read-only memory (ROM), programmable read-only memory (PROM), erasable programmable read-only memory (EPROM), electrically-erasable programmable read-only memory (EEPROM), and flash memory.

In an embodiment, the firmware code 242 is programmed to allow the data storage device 20 to regularly perform the operation of storing the event log file in a specific storage area in the data storage device 20. For example, the operation of storing the event log file in a specific storage area in the data storage device 20 is performed every minute, every hour, or every fixed period of time, but the present disclosure is not limited thereto. In other embodiments, the firmware code 242 is programmed to allow the data storage device 20 to perform the operation of storing the event log file in a specific storage area in the data storage device 20 only if a specific event occurs.

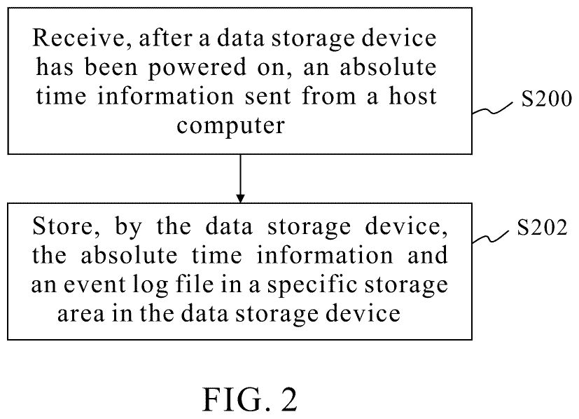

Referring to FIG. 2, there is shown a schematic view of a process flow of an event time recording method according to an embodiment of the present disclosure.

Step S200 entails executing, by the data storage device 20 after the data storage device 20 has been powered on, the firmware code 242 stored in the memory 24 and sending, by the data storage device 20, a request to the host computer 10. After receiving the request sent from the data storage device 20, the host computer 10 sends the absolute time information ATI to the data storage device 20, allowing the data storage device 20 to receive the absolute time information ATI sent from the host computer 10. The instances of the host computer 10 sending the absolute time information ATI are in the number of one or more.

Specifically speaking, after the data storage device 20 has received the absolute time information ATI, the absolute time information ATI is regarded as time information about the event log file recording each event. Therefore, the data storage device 20 need not change the original circuit design to use extra electric power (for example, a battery) to generate time information, and each event in the data storage device 20 has corresponding absolute time information, allowing computer technicians to access complete reference information during a troubleshooting process.

Step S202 entails storing, by the data storage device 20, the absolute time information ATI and the event log file in a specific storage area in the data storage device 20 to enable the computer technicians performing the troubleshooting process to search the specific storage area for the event log file and then compare the event log file with BIOS logs. In an embodiment, the data storage device 20 is configured to execute the firmware code 242 through the controller 22 to perform step S202 regularly, for example, every minute, every hour, or every fixed period of time, but the present disclosure is not limited thereto. Therefore, the event log file is stored periodically to save computational resources of the host computer 10.

In other embodiments, the data storage device 20 performs step S202 only if a specific event occurs. For example, the data storage device 20 is configured to execute the firmware code 242 through the controller 22 to inspect a specific event and perform step S202 only if the specific event occurs. The specific event is defined as an event that predisposes the data storage device 20 to damage or a malfunction, for example, a bad block, overly high temperature, read failure, and write failure. Therefore, it is not necessary to frequently perform the operation of storing the event log file, and thus it is feasible to save computational resources of the host computer 10.

Examples of the advantages of embodiments are as follows:

(1) Connection speed is a factor in the efficiency of data transmission between the host computer 10 and the data storage device 20, and thus a difference in the connection speed leads to unpredictability in applications that require a constant extent of transmission quality.

Computer technicians conventionally inspecting BIOS logs can only determine whether the host computer 10 is connected to the data storage device 20 but cannot perceive any issues with connection speed variations.

By contrast, in this embodiment, the computer technicians inspect the event log file comprising the absolute time information ATI and compare BIOS logs with the event log file in terms of time to determine whether the interface connection state of the data storage device 20 and the host computer 10 at “that point in time” is abnormal and identify events that not only precede and follow “that point in time” at which abnormal events occur but also affect the interface connection state so as to precisely determine the causes (for example, signal strength) of connection speed variations. Therefore, the event log file comprising the absolute time information ATI assists the computer technicians in tracing back error information of the data storage device 20 to analyze and determine whether signal strength affects connection speed variations.

(2) The data storage device 20 avoids a failure to read data through firmware management. For example, when the data storage device 20 ends up with a bad block, the bad block does not have any direct effect on the data of the host computer 10, because firmware assists with moving data to avoid a failure to read data. Thus, the computer technicians conventionally inspecting BIOS logs can only perceive the point in time at which the host computer 10 realizes data loss. The aforesaid point in time is likely to fall within the late stage of firmware-based data recovery, rendering it impossible to determine the causes of data loss. Even in some situations, if an error occurs to the data storage device 20 but is not detected by the host computer 10, the host computer 10 will not activate the recording of the error. As a result, BIOS logs will not record the event, adding to the difficulties in the computer technician's troubleshooting.

However, in an embodiment, the computer technicians inspecting the event log file comprising the absolute time information ATI can trace back and determine whether there is an increase in bad blocks during a time period that precedes data loss and thereby infer whether data loss is caused by the data storage device 20 or caused by any other components (for example, CPU, power management chip, and DRAM) of the host computer 10.

(3) The types of bad blocks and ECC bit number record are conducive to tracing back issues with the data storage device 20. For example, bad blocks occur to the data storage device 20 because of programming, erasing, or reading. The computer technicians inspecting the event log file comprising the absolute time information ATI can confirm the point in time at which the bad blocks occur and compare the aforesaid point in time with BIOS logs to identify the operation of the host computer 10 and determine whether it is necessary to specially adjust the firmware management technique of the data storage device 20 to achieve optimization and thereby reduce the probability of the generation of the bad blocks of the data storage device 20.

Likewise, the ECC bit number record is conducive to comprehension of data error condition of nonvolatile memory (for example, NAND flash). The computer technicians inspecting the event log file comprising the absolute time information ATI can confirm the hardware state of the data storage device 20 and thereby independently understand the state of the data storage device 20.

In conclusion, an event time recording method and a data storage device of the disclosure are effective in acquiring absolute time information sent from a host computer and storing the absolute time information and an event log file in the data storage device in a specific storage area in the data storage device to enable computer technicians to compare BIOS logs with the event log files in terms of the absolute time information to not only easily and quickly identify the causality between related devices upon the occurrence of an event but also enhance the precision in the analysis and judgment of causes of errors or failures arising from the operation of the host computer.

The present disclosure is described by way of the preferred embodiments above. A person skilled in the art should understand that, these embodiments are merely for illustrating the present invention and are not to be construed as limitations to the scope of the present disclosure. It should be noted that all equivalent changes, replacements and substitutions made to the embodiments are encompassed within the scope of the present disclosure. Therefore, the legal protection of the present disclosure should be defined by the appended claims and the scope of the claims should be in accordance with the broadest interpretation, so as to encompass all modifications, similar arrangements and processes.

What is claimed is:

1. An event time recording method, applicable to a data storage device, with the data storage device adapted to coordinate with a host computer, the event time recording method comprising the steps of:
receiving, after the data storage device has been powered on, an absolute time information sent from the host computer; and
storing, by the data storage device, the absolute time information and an event log file in a specific storage area in the data storage device.

2. The event time recording method of claim 1, wherein the host computer uses an Advanced Technology Attachment (ATA) command to send the absolute time information to the data storage device.

3. The event time recording method of claim 1, wherein record information of the event log file comprises an interface connection state, bad block position, bad block type, read failure, write failure, temperature, number of power-on hours, unrepairable position and/or error-correcting code.

4. The event time recording method of claim 1, wherein the data storage device regularly performs the step of storing the absolute time information and an event log file in a specific storage area in the data storage device.

5. The event time recording method of claim 1, wherein the data storage device performs the step of storing the absolute time information and an event log file in a specific storage area in the data storage device only if a specific event occurs.

6. A data storage device for recording event time, adapted to coordinate with a host computer, the data storage device comprising:
a controller; and
a memory electrically connected to the controller and adapted to store a firmware code,
wherein the firmware code is executed by the controller to perform the steps of:
receiving an absolute time information from the host computer; and
storing the absolute time information and an event log file in a specific storage area in the data storage device.

7. The data storage device of claim 6, wherein the host computer uses an Advanced Technology Attachment (ATA) command to send the absolute time information to the data storage device.

8. The data storage device of claim 6, wherein record information of the event log file comprises an interface connection state, bad block position, bad block type, read failure, write failure, temperature, number of power-on hours, unrepairable position and/or error-correcting code.

9. The data storage device of claim 6, wherein the data storage device regularly performs the step of storing the absolute time information and an event log file in a specific storage area in the data storage device.

10. The data storage device of claim 6, wherein the data storage device performs the step of storing the absolute time information and an event log file in a specific storage area in the data storage device only if a specific event occurs.
